(19) United States
(12) Patent Application Publication
(10) Pub. No.: US 2019/0220027 A1
(43) Pub. Date: Jul. 18, 2019

(54) VEHICLE CONTROL DEVICE

(71) Applicant: TOYOTA JIDOSHA KABUSHIKI KAISHA, Toyota-shi (JP)

(72) Inventors: Shu NAKAYAMA, Toyota-shi (JP); Takayuki AKAISHI, Toyota-shi (JP)

(73) Assignee: TOYOTA JIDOSHA KABUSHIKI KAISHA, Toyota-shi (JP)

(21) Appl. No.: 16/237,174

(22) Filed: Dec. 31, 2018

(30) Foreign Application Priority Data
Jan. 18, 2018 (JP) 2018-006248

(51) Int. Cl. G05D 1/02; B60R 16/033

(52) U.S. Cl. CPC G05D 1/0217; G01C 21/3469; B60R 16/033

(57) ABSTRACT

A vehicle control device is configured to control charge-discharge processing for detecting a battery state, the charge-discharge processing being executed for a battery also serving as a backup battery during automated driving. The vehicle control device includes a prediction setting section configured to predict a fluctuation in an input-output current of the battery also serving as the backup battery in a travel route for the automated driving based on map information, and to set a first travel section to a travel section where the fluctuation in the input-output current is predicted to be larger than a specified reference; and a control unit configured to control execution of the charge-discharge processing based on a fluctuation state of the input-output current of the battery also serving as the backup battery, and to prohibit the execution of the charge-discharge processing in the first travel section.

### INCORPORATION BY REFERENCE

The disclosure of Japanese Patent Application No. 2018-006248 filed on Jan. 18, 2018 including the specification, drawings and abstract is incorporated herein by reference in its entirety.

### BACKGROUND

### 1. Technical Field

The disclosure relates to a control device that is provided in a vehicle.

### 2. Description of Related Art

Each of Japanese Patent Application Publication No. 2017-081484 (JP 2017-081484 A) and Japanese Patent Application Publication No. 2016-203706 (JP 2016-203706 A) discloses a control method for efficiently consuming fuel and battery power on the basis of a charged state of a battery, traffic environment information, and vehicle information in a vehicle that can be driven in an automated driving mode.

### SUMMARY

In order to realize the control in each of JP 2017-081484 A and JP 2016-203706 A described above, it is necessary to accurately detect a state of charge (SOC) of the battery and a physical state (for example, an internal resistance value) of the battery. However, various loads, each of which causes fluctuations in electric power in accordance with a travel state of the vehicle, are connected to the battery. Accordingly, in the case where processing for detecting the physical state of the battery is executed when the fluctuations in the electric power due to the loads (i.e., fluctuations in, for example, the electric power consumed by the loads) are large, the processing is greatly affected by the fluctuations in the electric power, and the detection accuracy of the physical state of the battery may be degraded.

The disclosure provides a vehicle control device configured to accurately detect a physical state of a battery.

An aspect of the disclosure relates to a vehicle control device configured to control charge-discharge processing for detecting a battery state, the charge-discharge processing being executed for a battery also serving as a battery during automated driving. The vehicle control device includes a prediction setting section configured to predict a fluctuation in an input-output current of the battery also serving as the backup battery in a travel route for the automated driving based on map information, and to set a first travel section to a travel section where the fluctuation in the input-output current is predicted to be larger than a specified reference; and a control unit configured to control execution of the charge-discharge processing for detecting the battery state based on a fluctuation state of the input-output current of the battery also serving as the backup battery, and to prohibit the execution of the charge-discharge processing for detecting the battery state in the first travel section, the fluctuation state being predicted by the prediction setting section.

In the vehicle control device according to the above-described aspect, the charge-discharge processing for detecting the battery state is not executed in the travel section (the first travel section) where the fluctuation in the input-output current of the battery also serving as the backup battery is predicted to be larger than the specified reference due to a load associated with traveling of a vehicle. Due to the control, the charge-discharge processing can be executed while an influence of the fluctuation in the input-output current of the battery also serving as the backup battery is reduced. Therefore, the battery state can be accurately detected.

In the above-described aspect, the control unit may be configured to prohibit the charge-discharge processing for detecting the battery state from being newly initiated in a second travel section that is set to extend from a position where the first travel section starts, to a position that is before the first travel section and separated from the first travel section by a specified distance in the travel route.

In the control, the second travel section is set based on the time required for the charge-discharge processing for detecting the battery state, and thus it is possible to reduce the possibility that the charge-discharge processing for detecting the battery state is terminated prematurely. Thus, it is possible to reduce the possibility that the charge-discharge processing is terminated incompletely. Therefore, the battery state can further accurately be detected.

The first travel section where the input-output current of the battery also serving as the backup battery is predicted to fluctuate may include at least one of a curve where a steering operation of a vehicle is performed and a downhill where a braking operation of the vehicle is performed.

With the vehicle control device of the above aspect of the disclosure, a physical state of the battery can be accurately detected.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic configuration diagram illustrating a power supply system that includes a vehicle control device according to an embodiment of the disclosure;

FIG. 2 is a graph for explaining charge-discharge processing for detecting a state of a second battery;

FIG. 3 is a view illustrating an example in which travel sections are set on a curve and in the vicinity of the curve; and

FIG. 4 is a flowchart illustrating control for the charge-discharge processing, which is executed by the vehicle control device.

### DETAILED DESCRIPTION OF EMBODIMENTS

The disclosure relates to a vehicle control device that controls charge-discharge processing for detecting a battery state, and the charge-discharge processing is executed for a battery also serving as a backup battery during automated driving. This vehicle control device does not execute the charge-discharge processing for detecting this battery state in a travel section where fluctuations in electric power due to a load connected to the battery also serving as the backup battery are predicted to be large. Due to the control, the charge-discharge processing can be executed while an influence of fluctuations in an input-output current of the battery also serving as the backup battery is reduced. Therefore, the battery state can be accurately detected.

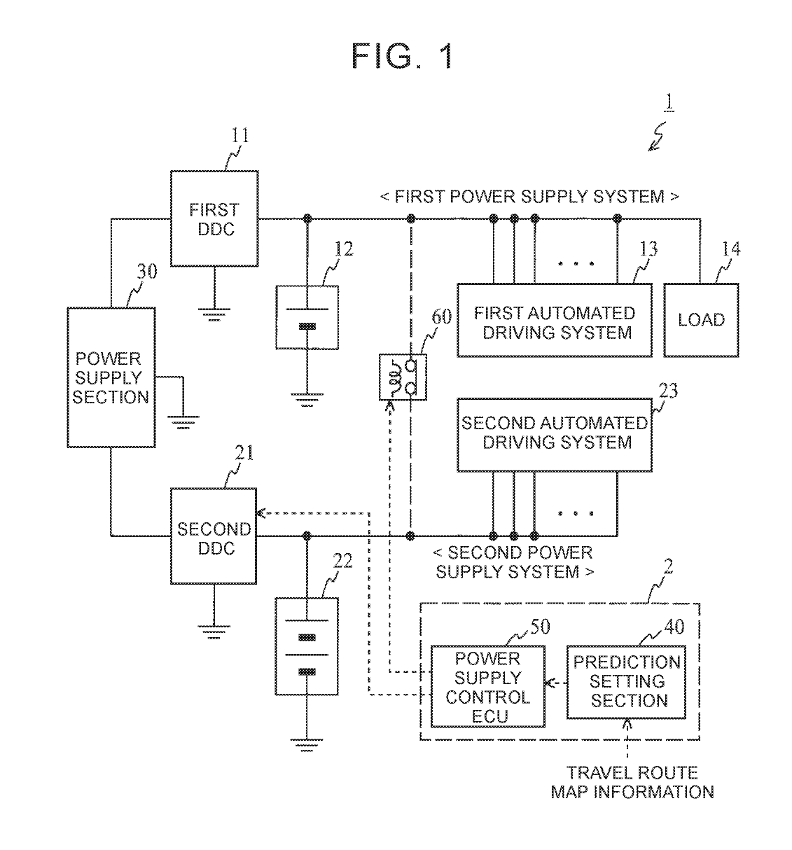

FIG. 1 is a schematic configuration diagram of a power supply system 1 that includes a vehicle control device 2 according to an embodiment of the disclosure. The power supply system 1 exemplified in FIG. 1 is configured to include a first power supply system including a first DC-DC converter (DDC) 11, a first battery 12, a first automated driving system 13, and a load 14; a second power supply system including a second DC-DC converter (DDC) 21, a second battery 22, and a second automated driving system 23; a power supply section 30; a prediction setting section 40; and a power supply control ECU 50. Configurations of the prediction setting section 40 and the power supply control electronic control unit (ECU) 50 may be regarded as the vehicle control device 2 according to this embodiment.

This power supply system 1 is provided in a vehicle in which a driving mode is switchable between a manual driving mode and an automated driving mode. In the manual driving mode, a driver drives the vehicle. In the automated driving mode, a vehicle system drives the vehicle. During the manual driving, in the power supply system 1, the first power supply system and the second power supply system are connected to each other (by turning on a relay unit 60, for example) such that the first battery 12 and the second battery 22 are used in parallel. During the automated driving, in the power supply system 1, the first power supply system and the second power supply system are disconnected from each other (by turning off the relay unit 60, for example) such that the second battery 22 is allowed to be used also as a backup battery that serves as an auxiliary power supply when the first battery 12 fails.

The power supply section 30 can supply electric power to the first DDC 11 provided in the first power supply system and the second DDC 21 provided in the second power supply system in parallel. This power supply section 30 can be a high-voltage battery such as a lithium-ion battery that is configured to be chargeable and dischargeable, for example.

The first DDC 11 is configured to be able to convert the electric power supplied from the power supply section 30 and output the converted electric power to the first battery 12, the first automated driving system 13, and the load 14. More specifically, the first DDC 11 lowers high-voltage electric power supplied from the power supply section 30 to low-voltage electric power and outputs the low-voltage electric power to the first battery 12, the first automated driving system 13, and the load 14.

The first battery 12 is an electric power storage element such as a lead battery that is configured to be chargeable and dischargeable, for example. This first battery 12 is configured to be able to store (be charged with) the electric power output from the first DDC 11 and to output stored electric power to the first automated driving system 13 and the load 14.

The first automated driving system 13 is a system including one or more load devices that are allocated to be operated with the use of the first battery 12 as a power supply, among load devices that are required for the automated driving of the vehicle.

The load 14 is one or more in-vehicle devices configured to be operated with the use of the electric power output from the first DDC 11 and/or the electric power stored in the first battery 12.

The second DDC 21 is configured to be able to convert the electric power that is supplied from the power supply section 30 and output the converted electric power to the second battery 22 and the second automated driving system 23. More specifically, the second DDC 21 lowers the high-voltage electric power supplied from the power supply section 30 to the low-voltage electric power and outputs the low-voltage electric power to the second battery 22 and the second automated driving system 23.

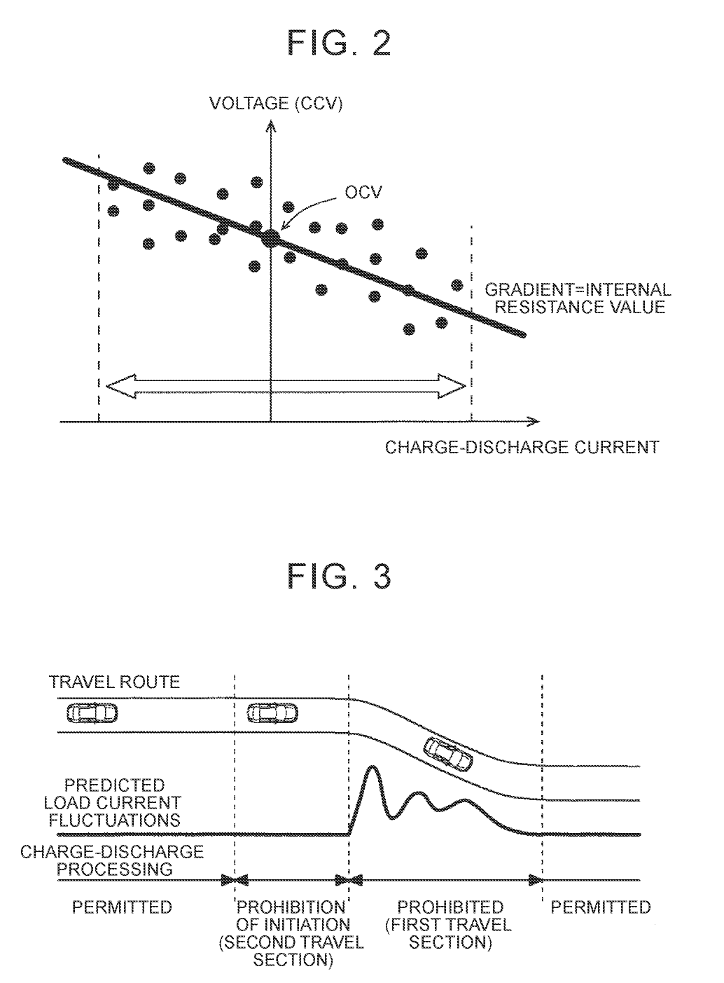

In addition, during the automated driving, the second DDC 21 executes specified charge-discharge processing for detecting a state of the second battery 22 on the basis of a command (a voltage command) from the power supply control ECU 50. A description will be provided on this charge-discharge processing with reference to FIG. 2.

In the charge-discharge processing, an output voltage of the second DDC 21 is fluctuated up and down (i.e., the output voltage of the second DDC 21 is increased and decreased) such that the second battery 22 is charged and discharged (i.e., the second battery 22 is charged with electric power and electric power is discharged from the second battery 22). The fluctuation width of this output voltage is set in advance such that values of a charge-discharge current (that is, a charge current and a discharge current) of the second battery 22 are dispersed to a given degree or greater, so as to increase the dispersion of current values (an arrow range in FIG. 2). In a period (for example, 20 seconds) in which the output voltage of the second DDC 21 is fluctuated up and down, a specified device that detects the battery state (for example, the power supply control ECU 50) measures a plurality of voltage values of the second battery 22 at given charge-discharge current values. Then, the specified device calculates an internal resistance value of the second battery 22 from a gradient of a current-voltage characteristic that is acquired from the plurality of measured voltage values and an open-circuit voltage (OCV). The state of the second battery 22 can be detected by calculating the internal resistance value.

Accuracy of this internal resistance value is increased as the degree of the dispersion of the values of the charge-discharge current of the second battery 22 is increased. However, in the above-described charge-discharge processing, in the case where the electric power fluctuates significantly (i.e., the fluctuations in the electric power are large) due to the load (the second automated driving system 23), the values of the charge-discharge current of the second battery 22 may not be dispersed as intended when the output voltage of the second DDC 21 is fluctuated up and down. As a result, the degree of the dispersion of the current values may be small. When the degree of the dispersion of the current values is small, the gradient of the current-voltage characteristic is not determined. As a result, the calculation accuracy of the internal resistance value of the second battery 22 is degraded. Thus, as will be described later, the vehicle control device 2 in this embodiment executes control to identify a travel section where the fluctuations in the electric power are large due to the load (the second automated driving system 23) in a travel route for the automated driving, and to prevent the execution of the charge-discharge processing in the travel section.

The second battery 22 is a power storage element such as the lead battery or the lithium-ion battery that is configured to be chargeable and dischargeable, for example. This second battery 22 is configured to be able to store (be charged with) the electric power output from the second DDC 21 and to output the stored electric power to the second automated driving system 23. The second battery 22 functions as a battery also serving as a backup battery. The second battery 22, that is, the battery also serving as a backup battery is used as the auxiliary power supply when the first battery 12 fails during the automated driving of the vehicle.

The second automated driving system 23 is a system including one or more load devices that are allocated to be operated with the use of the second battery 22 as the power supply, among load devices that are required for the automated driving of the vehicle. This second automated driving system 23 includes an electric power steering system, an electric brake system, and the like.

During the automated driving, the prediction setting section 40 acquires the travel route for the automated driving from a specified device (not shown) such as an automated driving control device, and also acquires map information related to the travel route for the automated driving from a specified device (not shown) such as a navigation system. Then, on the basis of the map information, the prediction setting section 40 predicts the electric power fluctuations due to the load (the second automated driving system 23) connected to the second battery 22, that is, the fluctuations in the input-output current of the second battery 22 (i.e., the current input to the second battery 22 and the current output from the second battery 22) in the travel route for the automated driving. Thereafter, on the basis of the prediction, the prediction setting section 40 sets the travel section in the travel route for the automated driving as follows.

For example, at a curve where a steering operation of the vehicle is performed, a large amount of the electric power is temporarily consumed by the electric power steering system in the second automated driving system 23. Thus, the prediction setting section 40 can predict that the current of the second battery 22 is increased by an amount equal to or larger than a specified value in a travel section including the curve. In addition, for example, on a downhill where a braking operation or regenerative braking is performed, the large amount of the electric power is temporarily consumed or stored due to the operation of the electric brake system in the second automated driving system 23. Thus, the prediction setting section 40 can predict that the current of the second battery 22 is increased or decreased by the amount equal to or larger than the specified value in a travel section including the downhill.

For the above reasons, the prediction setting section 40 sets a travel section where the fluctuations in the input-output current of the second battery 22 are predicted to be larger than a specified reference, as a “first travel section” where execution of the charge-discharge processing by the vehicle control device 2 is prohibited. In other words, the prediction setting section 40 sets the first travel section to the travel section where the fluctuations in the input-output current of the second battery 22 are predicted to be larger than a specified reference. In addition, the prediction setting section 40 can set a travel section before the first travel section as a “second travel section” where initiation of the charge-discharge processing by the vehicle control device 2 is prohibited, and the second travel section extends from a position where the first travel section starts, to a position that is before the first travel section and separated from the first travel section by a specified distance in the travel route. In other words, the prediction setting section 40 sets the second travel section to the travel section extending from the position where the first travel section starts, to the position that is before the first travel section and separated from the first travel section by the specified distance in the travel route. For example, the specified distance can be set on the basis of a period from the initiation of the charge-discharge processing to termination of the charge-discharge processing (a time required for the charge-discharge processing) and a vehicle speed in the automated driving.

FIG. 3 shows an example in which the first travel section and the second travel section are set on the curve and in the vicinity of the curve. In the example shown in FIG. 3, the first travel section is set to the curve where the predicted fluctuations in the load current (i.e., the input-output current) of the second battery 22 are large, and the second travel section is set to a section before the curve such that the charge-discharge processing is terminated before the vehicle enters the curve.

The above-described case where the input-output current of the second battery 22 fluctuates is merely one example. Thus, there are other cases where the input-output current of the second battery 22 fluctuates. For example, in a system configuration in which the input-output current of the second battery 22 fluctuates due to an operation of windshield wipers, it can be predicted that the output current of the second battery 22 is increased and decreased by the amount equal to or larger than the specified value in a travel section where rain is forecasted. Alternatively, in a system configuration in which the input-output current of the second battery 22 fluctuates due to lighting of lamps, it can be predicted that the output current of the second battery 22 is increased by the amount equal to or larger than the specified value in a travel section including a tunnel.

During the automated driving, the power supply control electronic control unit (ECU) 50 disconnects the first power supply system and the second power supply system from each other (by disconnecting the relay unit 60, for example), and instructs the second DDC 21 to execute the charge-discharge processing for detecting the battery state on the basis of a fluctuation state of the input-output current of the second battery 22, which is predicted by the prediction setting section 40, that is, the travel sections set by the prediction setting section 40.

More specifically, in the case where the vehicle is traveling in a section other than the first travel section and the second travel section, the power supply control ECU 50 provides the second DDC 21 with a command for permitting the charge-discharge processing. The command for the permission may be a command for indicating the values of the voltage to be output by the second DDC 21, for example. In the case where the vehicle is traveling in the first travel section, the power supply control ECU 50 provides the second DDC 21 with a command for prohibiting the charge-discharge processing. In the case where the vehicle is traveling in the second travel section, the power supply control ECU 50 provides the second DDC 21 with a command for prohibiting the initiation of the charge-discharge processing.

Note that the power supply control ECU 50 is typically configured to include a central processing unit (CPU), a memory, and an input-output interface, and the above-described specified functions are realized when the CPU reads out a program stored in the memory and executes the program.

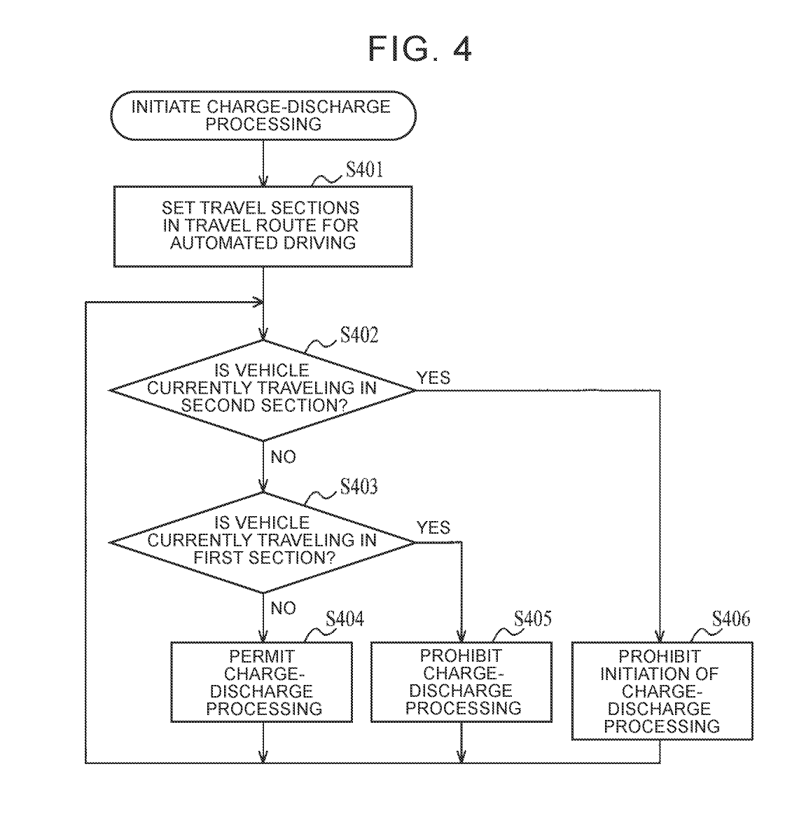

Next, with further reference to FIG. 4, a description will be provided on control executed by the vehicle control device according to the embodiment of the disclosure. FIG. 4 is a flowchart illustrating control for the charge-discharge processing, which is executed by the prediction setting section 40 and the power supply control ECU 50.

The control for the charge-discharge processing shown in FIG. 4 is initiated when the driving mode of the vehicle is switched from the manual driving to the automated driving. Then, the control for the charge-discharge processing is repeatedly executed until the driving mode of the vehicle is switched from the automated driving to the manual driving.

In Step S401, the prediction setting section 40 sets the first travel section and the second travel section in the travel route on the basis of the travel route for the automated driving acquired from the specified device.

In Step S402, the power supply control ECU 50 determines whether the vehicle is currently traveling in the second travel section. When the vehicle is not currently traveling in the second travel section (No in S402), the processing proceeds to step S403. When the vehicle is currently traveling in the second travel section (YES in S402), the processing proceeds to step S406.

In Step S403, the power supply control ECU 50 determines whether the vehicle is currently traveling in the first travel section. When the vehicle is not currently traveling in the first travel section (No in S403), the processing proceeds to step S404. When the vehicle is currently traveling in the first travel section (Yes in S403), the processing proceeds to step S405.

In Step S404, the power supply control ECU 50 permits the charge-discharge processing because the vehicle is currently traveling in the section other than the first travel section and the second travel section. In a period in which the charge-discharge processing is permitted, the charge-discharge processing can be initiated at timing at which the charge-discharge processing should be executed. Thus, the second battery 22 can be charged and discharged by fluctuating the output voltage of the second DDC 21 up and down.

In Step S405, the power supply control ECU 50 prohibits execution of the charge-discharge processing by the vehicle control device 2. In a period in which the charge-discharge processing is prohibited, the operation of charging and discharging the second battery 22 with the use of the second DDC 21 cannot be performed at all. That is, in the case where the charge-discharge processing has been already initiated, the operation of charging and discharging the second battery 22 is terminated prematurely, and the charge-discharge processing is not newly initiated. The control for prohibiting the charge-discharge processing is canceled when the vehicle passes the first travel section (No in S403).

In Step S406, the power supply control ECU 50 prohibits the initiation of the charge-discharge processing because the vehicle is currently traveling in the second travel section. In a period in which the initiation of the charge-discharge processing is prohibited, the operation of charging and discharging the second battery 22, which is associated with the already-initiated charge-discharge processing, can be continued until completed. However, the charge-discharge processing cannot be newly initiated. The control for prohibiting the initiation of the charge-discharge processing is canceled when the vehicle passes the second travel section and the first travel section (No in S402 and No in S403).

Note that the above-described second travel section where the initiation of the charge-discharge processing is prohibited may not be provided (steps S402 and S406 in FIG. 4 may be eliminated). In this case, measurement values measured in the charge-discharge processing that is still executed after the vehicle enters the first travel section may be discarded to prevent use of the measurement values.

The operation and effects in the embodiment will be described. In the vehicle control device 2 in the embodiment of the disclosure, the charge-discharge processing for detecting the battery state is not executed in the first travel section where the fluctuations of the input-output current of the second battery 22 are predicted to be larger than the specified reference due to the fluctuations in the electric power caused by the second automated driving system 23 that is connected to the second battery 22 also serving as the backup battery.

Due to the control, values of the charge-discharge current of the second battery 22, which correspond to the up-and-down fluctuations in the output voltage of the second DDC 21 in the charge-discharge processing, can be significantly dispersed as prescribed, while the dispersion of the values of the charge-discharge current is hardly influenced by fluctuations in the electric power due to the load (the second automated driving system 23) connected to the second battery 22. Accordingly, the voltage values, which are measured to calculate the internal resistance value of the second battery 22, can be appropriately dispersed. Therefore, the battery state (the internal resistance value) can be accurately detected.

Further, in the vehicle control device 2 in the embodiment of the disclosure, the charge-discharge processing for detecting the battery state is prohibited from being newly initiated in the second travel section before the first travel section, the second travel section being set on the basis of the time required for the charge-discharge processing for detecting the battery state.

Due to the control, it is possible to reduce the possibility that the charge-discharge processing for detecting the battery state is terminated prematurely. Accordingly, it is possible to reduce the possibility that the measurement of the voltage value to calculate the internal resistance value of the second battery 22 is terminated incompletely. Therefore, the battery state (the internal resistance value) can be further accurately detected.

The vehicle control device according to the embodiment of the disclosure includes two power supply systems and can be used for, for example, a vehicle in which a driving mode is switchable between a manual driving mode and an automated driving mode, the manual driving mode being a driving mode in which a driver drives the vehicle, and the automated driving mode being a driving mode in which a vehicle system drives the vehicle.

What is claimed is:

1. A vehicle control device configured to control charge-discharge processing for detecting a battery state, the charge-discharge processing being executed for a battery also serving as a backup battery during automated driving, the vehicle control device comprising:
a prediction setting section configured to predict a fluctuation in an input-output current of the battery also serving as the backup battery in a travel route for the automated driving based on map information, and to set a first travel section to a travel section where the fluctuation in the input-output current is predicted to be larger than a specified reference; and
a control unit configured to control execution of the charge-discharge processing for detecting the battery state based on a fluctuation state of the input-output current of the battery also serving as the backup battery, and to prohibit the execution of the charge-discharge processing for detecting the battery state in the first travel section, the fluctuation state being predicted by the prediction setting section.

2. The vehicle control device according to claim 1, wherein the control unit is configured to prohibit the charge-discharge processing for detecting the battery state from being newly initiated in a second travel section that is set to extend from a position where the first travel section starts, to a position that is before the first travel section and separated from the first travel section by a specified distance in the travel route.

3. The vehicle control device according to claim 1, wherein the first travel section includes at least one of a curve where a steering operation of a vehicle is performed and a downhill where a braking operation of the vehicle is performed.
